(19) United States
(12) Patent Application Publication
(10) Pub. No.: US 2011/0084909 A1
(43) Pub. Date: Apr. 14, 2011

(54) Electronic apparatus and method of changing keyboard thereof

(75) Inventors: Sung-Yu Hsieh, Taipei Hsien (TW); Chu-Chieh Chen, Taipei Hsien (TW); Pei-Ling Lai, Taipei Hsien (TW); Pin-Hsien Su, Taipei Hsien (TW); Hsiang-Ling Hsu, Taipei Hsien (TW)

(73) Assignee: Wistron Corporation, Taipei Hsien (TW)

(21) Appl. No.: 12/662,791

(22) Filed: May 4, 2010

(30) Foreign Application Priority Data
Oct. 8, 2009 (TW) 098134206

(51) Int. Cl. G06F 3/02

(52) U.S. Cl. 345/170

(57) ABSTRACT

An electronic apparatus is disclosed. The electronic apparatus comprises a display module, a detecting module, a keyboard module and a processing module. The detecting module is capable of detecting a position of the display module. The keyboard module comprises a key portion and a plurality of light guide structures. The key portion comprises at least one physical key. Each light guide structure comprises a light source and a light guide element having at least one icon corresponding to the at least one physical key formed on a surface of the light guide element. The processing module can select a different light guide structure according to the position of the display module to show the at least one icon on the key portion corresponding to the position of the display module.

### BACKGROUND OF THE INVENTION

1. Field of the Invention

The present invention relates to an electronic apparatus, and more particularly, to an electronic apparatus which can change icons displayed on the keyboard according to its position.

2. Description of the Related Art

Generally, small electronic apparatus such as a cellular phone, a PDA, or a GPS device tends to use a touch screen to replace the keyboard on account of limited size, thereby saving space and improving portability. However, some of the electronic apparatuses still use physical keyboards along with touch screen due to the following reasons: first, the manufacturing cost of the touch screen rises as the screen size gets bigger, electronic apparatus with a large touch screen, such as electronic books (or e-books) could suffer from high manufacturing cost; second, not like the physical keyboard, the touch screen does not provide force feedback mechanism, therefore it could be bad for user's hands and wrists for long term use.

Furthermore, since e-books have to support vertical or horizontal displays for different data formats, the devices have to be placed upright or traverse to provide better viewing of the display contents. For e-books equipped with physical keyboards, they will rotate along with their keyboards, making it inconvenient for the user to recognize icons on the keyboard and to perform any input operations with the keyboard since the keyboard does not face directly to the user.

### SUMMARY OF THE INVENTION

It is an object of the present invention to provide an electronic apparatus which can change icons displayed on the keyboard according to its position.

In order to achieve the above object, the present invention discloses an electronic apparatus comprising a display module, a detecting module, a keyboard module, and a processing module. The detecting module detects a position of the display module; the keyboard module comprising a key portion and a plurality of light guide structures, the key portion is disposed on the plurality of overlapping light guide structures and comprises at least one physical key, each light guide structure comprises a light source and a light guide element which has at least one icon corresponding to the at least one physical key formed on a surface of the light guide element, the light source is lit to illuminate the at least one icon through the light guide element, wherein each one of the at least one icon on a different light guide element has a different icon direction; the processing module selects a different light guide structure according to the position of the display module to show the at least one icon on the key portion corresponding to the position of the display module. Therefore, the electronic apparatus of the present invention can change the icons displayed on the keyboard according to its position to facilitate user operations.

In another embodiment of the present invention, the keyboard module comprises a key portion and at least one light guide structure, the key portion is disposed on the at least one light guide structure, the key portion comprises at least one physical key, the at least one physical key has at least one setup icon disposed on a surface thereof; each light guide structure comprises a light source and a light guide element which has at least one first icon corresponding to the at least one physical key formed on a surface of the light guide element, the light source is lit to illuminate the at least one first icon through the light guide element, wherein each one of the at least one setup icon has a different icon direction other than that of the at least one first icon; the processing module determines whether to select a different light guide structure according to the position of the display module to show the at least one first icon or the setup icon on the key portion corresponding to the position of the display module.

A keyboard changing method for an electronic apparatus is disclosed, the method comprising: detecting a position of the display module; and showing at least one icon through the keyboard module according to the position of the display module, wherein the at least one icon has an icon direction corresponding to the position of the display module.

### BRIEF DESCRIPTION OF THE DRAWINGS

FIG. 1 illustrates a system block diagram for an electronic apparatus in the present invention;

FIG. 2 illustrates a structural view of a keyboard module of the electronic apparatus in a first embodiment of the present invention;

FIG. 3 illustrates a view of using a light guide structure to show an icon in the present invention;

FIG. 4 illustrates a structural view of a keyboard module of the electronic apparatus in a second embodiment of the present invention;

FIG. 5 illustrates a flowchart of a keyboard changing method in the present invention;

FIG. 6A and FIG. 6B illustrate operational views of using the keyboard changing method for the electronic apparatus in the first embodiment of the present invention; and

FIG. 7A and FIG. 7B illustrate operational views of using the keyboard changing method for the electronic apparatus in the second embodiment of the present invention.

### DETAILED DESCRIPTION OF THE PREFERRED EMBODIMENT

The advantages and innovative features of the invention will become more apparent from the following detailed description when taken in conjunction with the accompanying drawings.

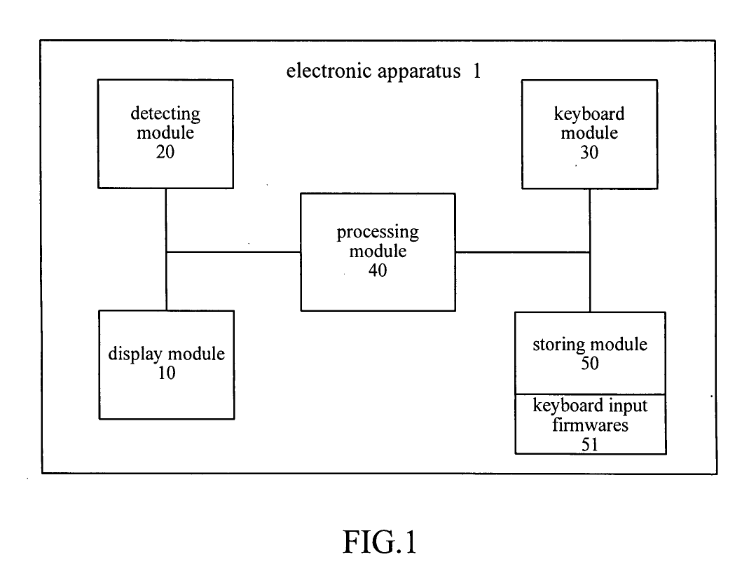

Please refer to FIG. 1 for a system block diagram of an electronic apparatus in the present invention. As shown in FIG. 1, an electronic apparatus 1 comprises a display module 10, a detecting module 20, a keyboard module 30, a processing module 40, and a storing module 50. The processing module 40 is electrically coupled with the display module 10, the detecting module 20, the keyboard module 30, and the storing module 50. The detecting module 20 detects a rotation of the display module 10 with respect to any axis (such as X-axis, Y-axis, or Z-axis) to calculate a position of the display module 10 in the space and to transmit a position data of the display module 10 to the processing module 40. The detecting module 20 can be a three-axis gravity sensor (G-sensor) or any other devices which provide detecting capabilities. The keyboard module 30 can use each physical key (not shown in figure) to input each corresponding input code and to show the corresponding icon by each physical key. The storing module 50 stores at least one keyboard input firmware 51, each keyboard input firmware 51 defines input codes for each physical key of the keyboard module 30; therefore, after the keyboard input firmware 51 is loaded, an user can input the input code corresponding to the physical key by pressing the physical key of the keyboard module 30. The processing module 40 can comprise a CPU, south bridge/north bridge chips and a microprocessor for processing and transmitting instructions between modules. The processing module 40 receives the position data from the detecting module 20 and determines a corresponding mode according to the position of the display module 10, and shows at least one icon on the keyboard module 30 corresponding to the position of the display module 10.

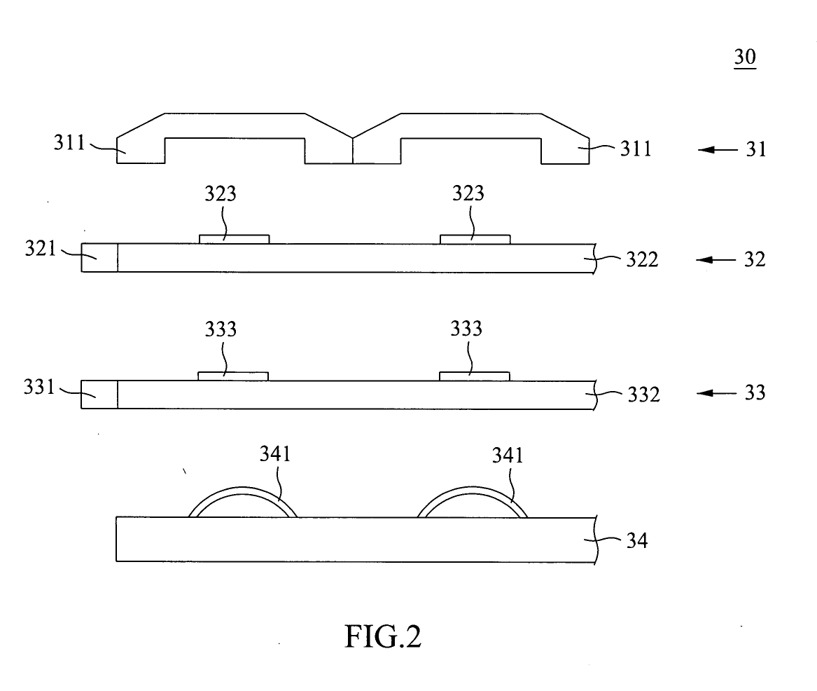

FIG. 2 illustrates a structural view of the keyboard module 30 of the electronic apparatus 1 in a first embodiment of the present invention. As shown in FIG. 2, in this embodiment, the keyboard module 30 comprises a key portion 31, a first light guide structure 32, a second light guide structure 33, and a circuit board 34. The key portion 31 is disposed on the overlapping first light guide structure 32 and the second light guide structure 33, and the key portion 31 comprises at least one physical key 311, while each physical key 311 is made of a light transmitting material.

The first light guide structure 32 comprises a first light source 321 and a first light guide element 322, the second light guide structure 33 comprises a second light source 331 and a second light guide element 332, wherein the first light guide element 322 and the second light guide element 332 are both light guide films. The first light guide element 322 and the second light guide element 332 are disposed with at least one first icon 323 and at least one second icon 333 corresponding to the at least one physical key 311 respectively. Each first icon 323 and each second icon 333 are patterns of light transmitting notches formed by processing the surfaces of the first light guide element 322 and the second light guide element 332 respectively, the patterns can be all kinds of alphabets, numbers, symbols or any other functional diagrams.

The circuit board 34 is disposed under the second light guide structure 33 and is electrically connected to a keyboard controller (not shown in figure), the circuit board 34 comprises at least one contact pad 341, each contact pad 341 corresponds to a physical key 311; therefore, when the user presses one physical key 311, it will trigger the contact pad 341 to transmit the corresponding input code of the physical key 311 to the processing module 40 through the keyboard controller.

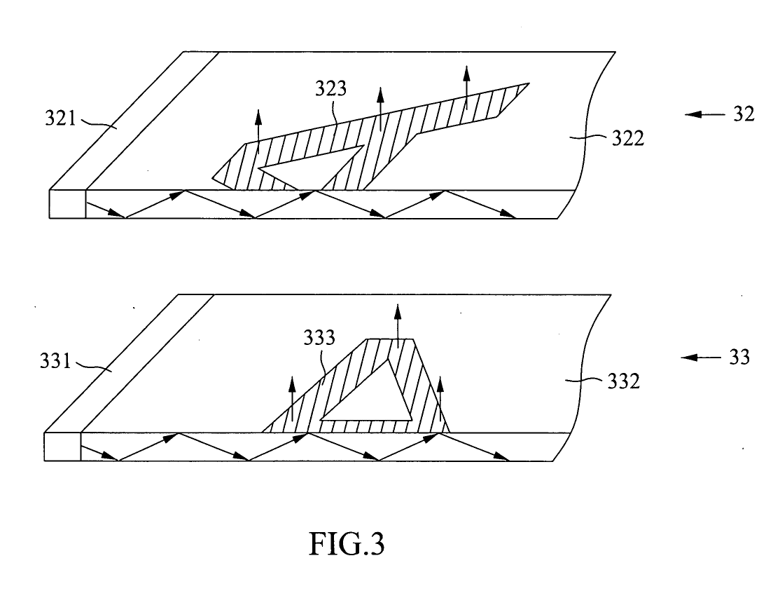

Please refer to FIG. 3 for a view of using a light guide structure to show an icon in the present invention. As shown in FIG. 3, with the first light guide structure 32 as an example, when the first light source 321 is lit, the light radiated from the first light source 321 is guided into the first light guide element 322 to reach where each first icon 323 is, at this time the light is refracted by each first icon 323 to radiate along a plane orthogonal to the surface of the first light guide element 322; therefore, each first icon 323 is shown by using the first light guide element 322. Similarly, for the second light guide structure 33, when the second light source 321 is lit, each second icon 333 is shown by using the second light guide element 332. In this embodiment, the at least one first icon 323 and the at least one second icon 333 have different icon directions, in other words, the first icon 323 and the second icon 333 correspond to different view angles of the user. Besides, the light radiated by the first light source 321 and the second light source 331 may provide different light colors to each first icon 323 and each second icon 333 respectively.

From the first embodiment of the electronic apparatus 1, the processing module 40 can select a corresponding light guide structure according to the position of the display module 10. Each icon on the light guide element may be shown through the corresponding physical key by lighting the light source of the selected light guide structure. The icon direction of each icon on the same light guide element coincides with the position of the display module which the same light guide structure corresponds to. However, it is noted that the number of the light guide structure is not limited to two, and any other number of the light guide structure can be applied according to different designs of the electronic apparatus 1 and the position of the display module, making the illustrated icons more versatile.

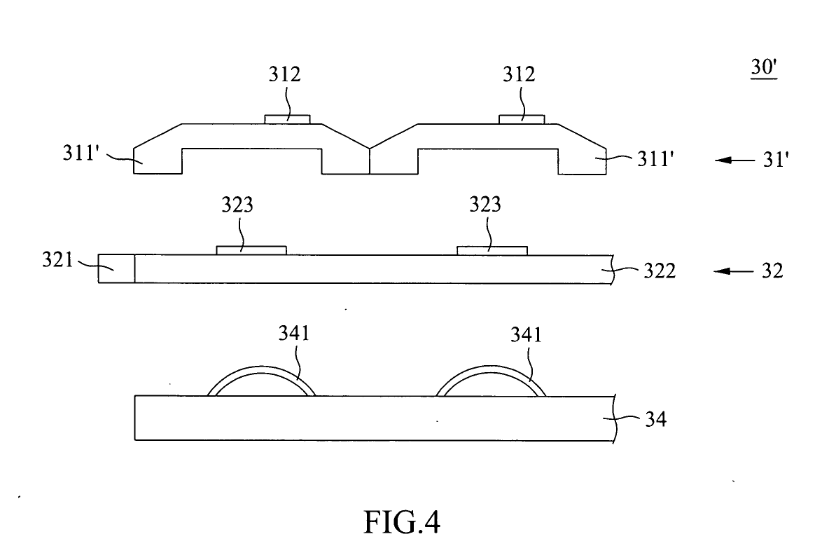

Please refer to FIG. 4 for a structural view of a keyboard module 30′ of the electronic apparatus 1′ in a second embodiment of the present invention. The second embodiment is a variation of the first embodiment. As shown in FIG. 4, in this embodiment, a keyboard module 30′ comprises a key portion 31′, the first light guide structure 32 and the circuit board 34. The key portion 31′ is disposed on the first light guide structure 32, the key portion 31′ comprises at least one physical key 311′, the at least one physical key 311′ has at least one setup icon 312 disposed on the surface thereof. Each physical key 311′ is made of a light transmitting material. The first light guide structure 32 comprises the first light source 321 and the first light guide element 322, the first light guide element 322 is a light guide film. The first light guide element 322 is disposed with at least one first icon 323 corresponding to the at least one physical key 311′ on the surface thereof. Each first icon 323 is a pattern of a light transmitting notch formed by processing the surfaces of the first light guide element 322, the patterns can be all kinds of alphabets, numbers, symbols or any other functional diagrams. The circuit board 34 is disposed under the first light guide structure 32, the circuit board 34 comprises at least one contact pad 341, each contact pad 341 corresponds to a physical key 311′; therefore, when the user press one physical key 311′, it will trigger the corresponding contact pad 341 to transmit the input code of the physical key 311′. The at least one setup icon 312 and the at least one first icon 323 have different icon directions. In other words, the setup icon 312 and the first icon 323 correspond to different view angles of the user.

By using the electronic apparatus 1′ in the second embodiment of the present invention, the electronic apparatus 1′ has the at least one setup icon 312 corresponding to a certain position of the display module on each physical key 311′, and each setup icon 312 has its icon direction coincided with a corresponding position of the display module. Hence, the processing module 40 can determine whether to use the corresponding first light guide structure to show a corresponding first icon on each physical key according to the position of the display module, or simply uses the at least one setup icon 312 corresponding to the position of the display module. The icon direction of each icon on the same light guiding element coincides with the position of the display module which the same light guide structure corresponds to. However, it is noted that the number of the light guide structure is not limited to that describe in this embodiment and can be adjusted according to the design of the electronic apparatus 1′. Furthermore, the light sources used in the present invention can be LEDs or other similar light emitting devices.

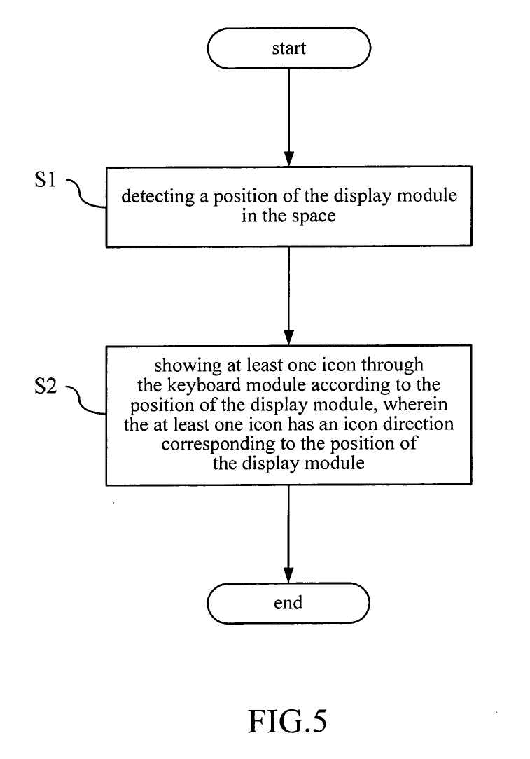

Please refer to FIG. 5 for a flowchart of a keyboard changing method in the present invention. As shown in FIG. 5, the keyboard changing method comprises step S1 to step S3, which will be described in detail:

Step S1: detecting a position of the display module 10 in the space. As shown in FIG. 1, the electronic apparatus 1 uses the detecting module 20 to detect a rotation of the display module 10 with respect to any axis (such as X-axis, Y-axis, or Z-axis) to calculate a position of the display module 10 in the space and to transmit a position data of the display module 10 to the processing module 40. In this embodiment, the detecting module 20 detects the rotation of the display module 10 with respect to Z-axis (which is substantially orthogonal to surface of the display module 10), but the present invention can use other axis as reference.

Step S2: showing at least one icon through the keyboard module 30 according to the position of the display module 10, wherein the at least one icon has an icon direction corresponding to the position of the display module 10. In this embodiment, the positions of the display module 10 of the electronic apparatus 1 are classified into an upright position and a traverse position; however, the present invention is not limited to these positions, for example, the display module 10 can have a different position when it is rotated for every 90 degrees. The processing module 40 determines the current position is an upright position or a traverse position according to the position data, then the processing module 40 informs the keyboard module 30 to show the at least one icon corresponding to the upright position or the traverse position for facilitating user operations.

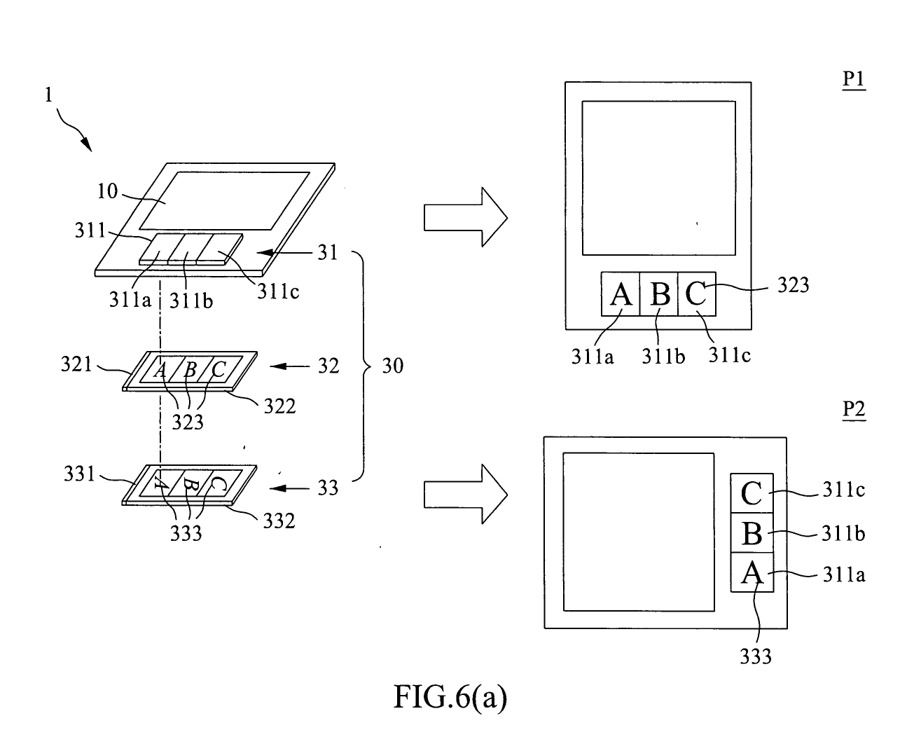

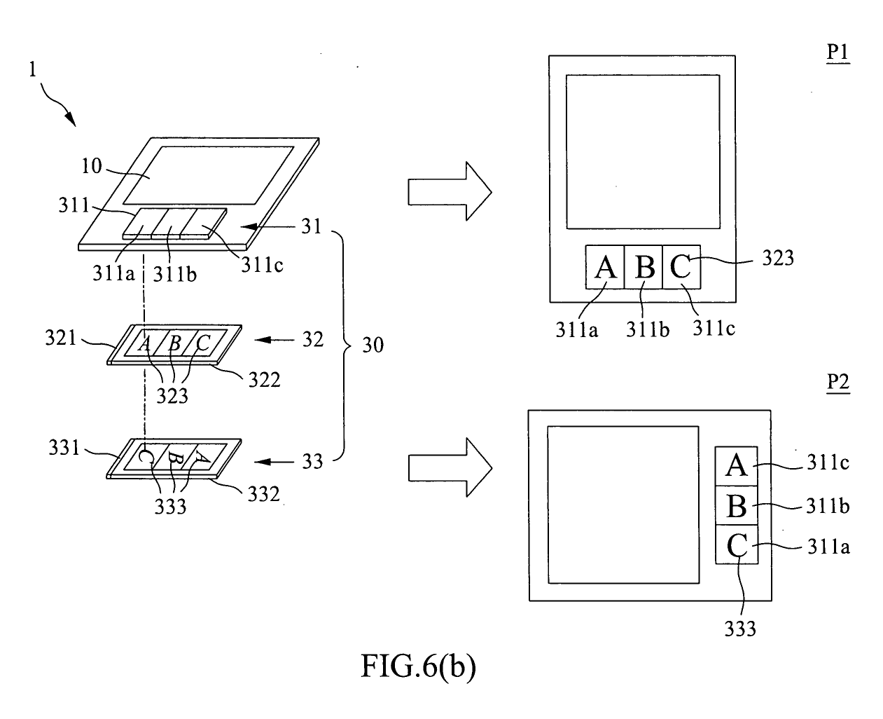

FIG. 6A and FIG. 6B illustrate operational views of using the keyboard changing method for the electronic apparatus 1 in the first embodiment of the present invention. As shown in FIG. 6(a), the electronic apparatus 1 disposes each first icon 323 of the first light guide element 322 and each second icon 333 of the second light guide element 332 which both correspond to the same physical key 311 on locations corresponded with each other. In this embodiment, the first icon 323 of the first light guide element 322 and the second icon 333 of the second light guide element 332 both correspond to the same physical key 311, and comprise the same icon with different icon directions.

Suppose the key portion 31 comprises three physical keys 311a, 311b, and 311c with the corresponding first icons 323 being alphabets “A”, “B”, and “C” respectively and the corresponding second icons 333 being the alphabets “A”, “B”, and “C” after a 90-degree rotation respectively. When the electronic apparatus 1 is disposed at a upright position P1, the processing module 40 selects the first light guide structure 32 and has the first light source 321 lit to show the first icons 323 of alphabets “A”, “B”, and “C”, corresponding to the upright position P1; when the electronic apparatus 1 is rotated about 90 degrees to a traverse position P2, the processing module 40 selects the second light guide structure 33 and has the second light source 331 lit to show the second icon 333 of alphabets “A”, “B”, and “C” after a 90-degree rotation, corresponding to the traverse position P2.

Also shown in FIG. 6B, in this embodiment, each first icon 323 of the first light guide element 322 and each second icon 333 of the second light guide element 332 which both correspond to the same physical key 311 comprise different icons with different icon directions. Therefore the arrangements and the contents of the icons are varied.

Suppose the key portion 31 comprises three physical keys 311a, 311b, and 311c with the corresponding first icons 323 being alphabets “A”, “B”, and “C” respectively and the corresponding second icons 333 being alphabets “C”, “B”, and “A” after a 90-degree rotation respectively. When the electronic apparatus 1 is disposed at the upright position P1, the keyboard module 30 shows the first icon 323 of alphabets “A”, “B”, and “C” corresponding to the upright position P1; when the electronic apparatus 1 is rotated 90 degree to the traverse position P2, the keyboard module 30 shows the second icon 333 of alphabets “C”, “B”, and “A” after a 90-degree rotation; therefore, the arrangement of the icons is changed. The electronic apparatus 1 stores two sets of keyboard input firmwares in the storing module 50, these two sets of keyboard input firmwares define the input code of the first icons 323 corresponding to the physical keys 311a, 311b, and 311c of the keyboard module 30 at the upright position P1 and the input code of the second icons 333c corresponding to the physical keys 311a, 311b, and 311c of the keyboard module 30 at the traverse position respectively. The processing module 40 can load the corresponding keyboard input firmware according to the position of the display module. Therefore, when the icon corresponding to each physical key 311 is changed, each input code for each corresponding icon can be loaded. Accordingly, the electronic apparatus 1 can have each physical key 311 of the keyboard module 30 corresponded to different input code and icons.

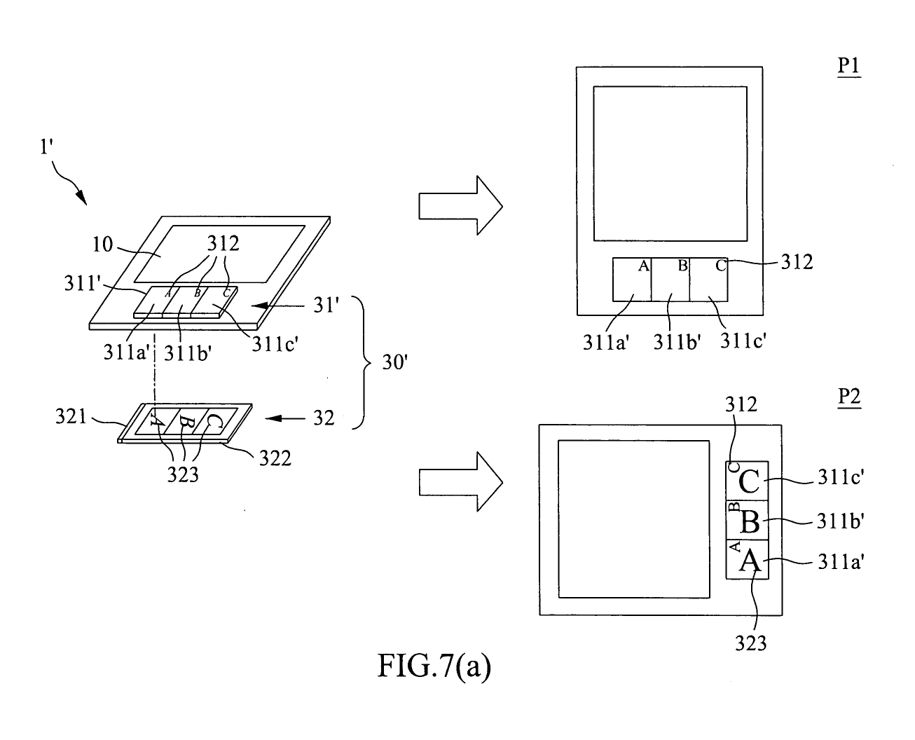

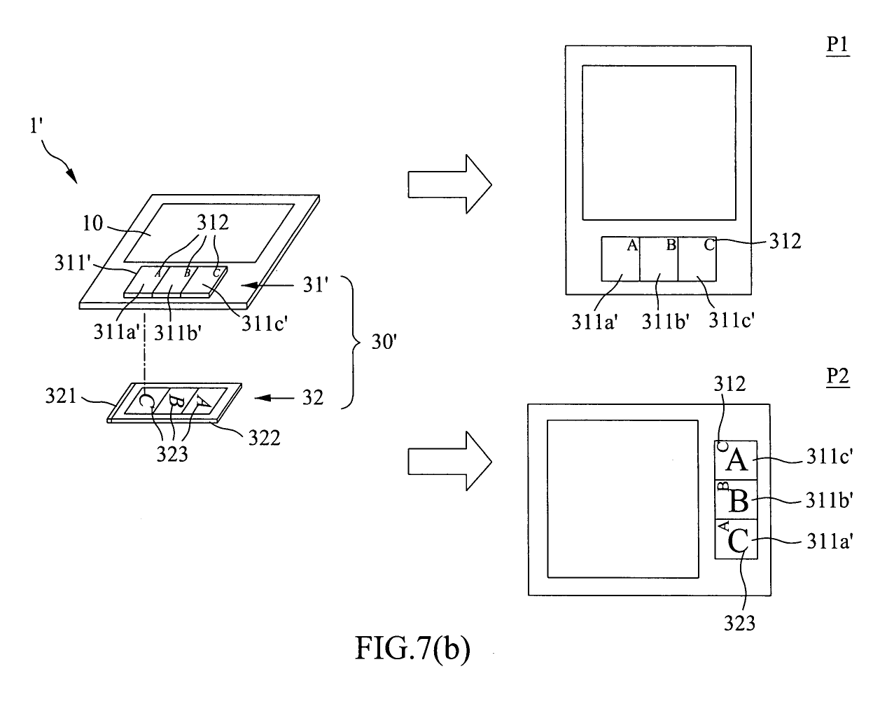

FIG. 7A and FIG. 7B illustrate operational views of using the keyboard changing method for the electronic apparatus 1′ in the second embodiment of the present invention. As shown in FIG. 7A, the electronic apparatus 1′ disposes each setup icon 312 and each first icon 323 of the first light guide element 322 which both correspond to the same physical key 311′ on locations corresponded with each other. In this embodiment, the setup icon 312 and the first icon 323 of the first light guide element 322 both correspond to the same physical key 311′ and comprise the same icon with different icon directions.

Suppose the key portion 31 comprises three physical keys 311a′, 311b′, and 311c′ with the corresponding setup icons 312 being alphabets “A”, “B”, and “C” respectively and the corresponding first icons 323 being alphabets “A”, “B”, and “C” after a 90-degree rotation respectively. When the electronic apparatus 1 is disposed at the upright position P1, the setup icons 312 corresponding to the physical key 311a′, 311b′, and 311c′ are used as the icons, that is, “A”, “B”, and “C”; when the electronic apparatus 1′ is rotated 90 degrees to the traverse position P2, the processing module 40 can select the first light guide structure 32 and have the first light source 321 lit to show the first icons 323 corresponding to the traverse position, that is, “A”, “B”, and “C” after a 90-degree rotation.

Also shown in FIG. 7B, in this embodiment, the setup icon 312 and the first icon 323 of the first light guide element 322 both correspond to the same physical key 311′ and comprise different icons with different icon directions. The principle and the operation shown in FIG. 7B are similar to those shown in FIG. 6B, except that this embodiment uses the setup icons 312 on the physical keys instead of another light guide structure to correspond with a certain position of the display module.

It is noted that the above-mentioned embodiments are only for illustration, it is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An electronic apparatus, comprising:
a display module;
a detecting module for detecting a position of the display module;
a keyboard module comprising a key portion and a plurality of light guide structures, the key portion being disposed on the plurality of overlapping light guide structures and comprising at least one physical key, each light guide structure comprising a light source and a light guide element which has at least one icon corresponding to the at least one physical key formed on a surface of the light guide element, the light source being lit to illuminate the at least one icon through the light guide element, wherein each one of the at least one icon on a different light guide element has a different icon direction; and
a processing module electrically coupled with the display module, the detecting module and the keyboard module, the processing module selecting a different light guide structure according to the position of the display module to show the at least one icon on the key portion corresponding to the position of the display module.

2. The electronic apparatus as claimed in claim 1, wherein each icon corresponding to the same physical key and on a different light guide element is disposed at a corresponding location.

3. The electronic apparatus as claimed in claim 2, wherein each icon corresponding to the same physical key and on a different light guide element comprises a same pattern with a different icon direction.

4. The electronic apparatus as claimed in claim 2, wherein each icon corresponding to the same physical key and on a different light guide element comprises a different pattern with a different icon direction.

5. The electronic apparatus as claimed in claim 4 further comprising a storing module for storing a plurality of keyboard input firmwares, each keyboard input firmware defining each input code of each icon corresponding to each of the at least one physical key of the keyboard module; wherein the processing module loads the corresponding keyboard input firmware according to the position of the display module for each physical key, so as to load each input code corresponding to each icon.

6. The electronic apparatus as claimed in claim 1, wherein each light guide structure uses the light source of a different color respectively so as to let the key portion show a different color of each icon according to the position of the display module.

7. The electronic apparatus as claimed in claim 1, wherein each icon is a light transmitting notch formed by processing the surface of the light guide element.

8. The electronic apparatus as claimed in claim 1, wherein the detecting module detects a rotation of the display module with respect to any axis to determine the position of the display module.

9. The electronic apparatus as claimed in claim 1, wherein the detecting module is a three-axis gravity sensor (G-sensor).

10. A keyboard changing method for the electronic apparatus according to claim 1, the electronic apparatus comprising the display module and the keyboard module, the method comprising:
detecting a position of the display module; and
showing at least one icon through the keyboard module according to the position of the display module, wherein the at least one icon has an icon direction corresponding to the position of the display module.

11. The method as claimed in claim 10, wherein each physical key of the keyboard module corresponds to a different input code and a different icon according to the position of the display module.

12. An electronic apparatus, comprising:
a display module;
a detecting module for detecting a position of the display module;
a keyboard module comprising a key portion and at least one light guide structure, the key portion being disposed on the at least one light guide structure, the key portion comprising at least one physical key, the at least one physical key having at least one setup icon disposed on a surface thereof; each light guide structure comprising a light source and a light guide element which has at least one first icon corresponding to the at least one physical key formed on a surface of the light guide element, the light source being lit to illuminate the at least one first icon through the light guide element, wherein each one of the at least one setup icon has a different icon direction other than that of the at least one first icon; and
a processing module electrically coupled with the display module, the detecting module and the keyboard module, the processing module determining whether to select a different light guide structure according to the position of the display module to show the at least one first icon or setup icon on the key portion corresponding to the position of the display module.

13. The electronic apparatus as claimed in claim 12, wherein each setup icon and each first icon corresponding to the same physical key comprise a same pattern with different icon directions.

14. The electronic apparatus as claimed in claim 12, wherein each setup icon and each first icon corresponding to the same physical key comprise different patterns with different icon directions.

15. The electronic apparatus as claimed in claim 14 further comprising a storing module for storing a plurality of keyboard input firmwares, each keyboard input firmware defining each input code of each setup icon or each first icon for the at least one physical key of the keyboard module respectively; wherein the processing module loads the corresponding keyboard input firmware according to the position of the display module for each physical key, so as to load each input code corresponding to each setup icon or each first icon.

16. The electronic apparatus as claimed in claim 12, wherein the first icon is a light transmitting and refraction portion formed by processing the surface of the light guide element.

17. The electronic apparatus as claimed in claim 12, wherein the detecting module detects a rotation of the display module with respect to any axis to determine the position of the display module.

18. The electronic apparatus as claimed in claim 12, wherein the detecting module is a three-axis gravity sensor (G-sensor).
